(19) United States
(12) Patent Application Publication
(10) Pub. No.: US 2021/0389976 A1
(43) Pub. Date: Dec. 16, 2021

(54) TECHNIQUES TO FACILITATE A MIGRATION PROCESS TO CLOUD STORAGE

(71) Applicant: Capital One Services, LLC, McLean, VA (US)

(72) Inventors: Adnan Haq, Glen Allen, VA (US); Akhil Vasudevan Nair, Glen Allen, VA (US)

(73) Assignee: Capital One Services, LLC, McLean, VA (US)

(21) Appl. No.: 16/899,195

(22) Filed: Jun. 11, 2020

(51) Int. Cl. G06F 9/48; G06F 9/50; G06F 9/38; G06F 21/62; H04L 29/08

(52) U.S. Cl. CPC G06F 9/4862; G06F 9/5077; H04L 67/28; G06F 21/6245; G06F 9/3867

(57) ABSTRACT

Techniques to facilitate a migration process of source data to cloud storage are described. These techniques use configuration information with pre-configured settings for the migration process by leveraging such information to build a component to execute the migration process. These settings can be used to identify computing modules (including interfaces) for generating a script for loading the source data to a storage location managed by a cloud storage service. The script may rely upon a data model for organizing the source data, which also is provided in the settings. Once the source data is available, the source data is converted into a suitable migration dataset and communicated with the script to the cloud storage service in a single operation. Other embodiments are described and claimed.

### BACKGROUND

Organizations, including multi-national corporations, invest in technological equipment to meet their informational technology demands and personnel to operate such equipment. The same organizations are looking for ways to reduce costs related to such equipment and personnel. This includes the purchasing of cloud storage/computing services in terms of capabilities and/or capacities. For instance, an organization may purchase storage space with a capacity (e.g., one (1) terabyte) and a particular data transfer rate in addition to a compute node with a capability of loading database records with JAVA code. Cloud-based services offer several advantages (in general) over an on-premises enterprise facility housing various types of storage technologies; valuable time and resources at that facility can be used for other enterprise tasks. While there are advantages, managing cloud-based services, however, can be tedious and expensive. When a file or set of files arrives at the on-premises facility for migration to the cloud storage, the file or set of files have to be manually configured by personnel for that migration.

It is with respect to these and other considerations that the present improvements have been desired.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to facilitate a migration process to cloud storage of source data from various client devices. Some embodiments are particularly directed to techniques to leverage configuration information with pre-configured settings for building a component to execute the migration process. Different computing modules (including interfaces) may be added or removed from the component as needed for a particular migration.

In one embodiment, for example, an apparatus may comprise a processing circuit and logic stored in computer memory and executed on the processing circuit, the logic operative to cause the processing circuit to access configuration information associated with migrating source data to cloud storage. The configuration information includes settings directed towards storing the source data in the cloud storage. The logic is further operative to cause the processing circuit to convert file data into a migration dataset in accordance with the settings in the configuration information. The file data is to be migrated to a storage location over a network. The logic is further operative to cause the processing circuit to generate a script comprising operations for storing the migration dataset file data in the migration dataset. The script being based upon the settings in the configuration information. The logic is further operative to cause the processing circuit to communicate the script and the migration dataset to a server associated with the cloud storage service, the server configured to execute the script and store the migration dataset in the storage location in accordance with the settings in the configuration information. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system to facilitate a migration process to cloud storage of source data.

FIG. 2 illustrates an embodiment of an apparatus to implement the system of FIG. 1.

FIG. 3 illustrates embodiments of example operating environments for the system of FIG. 1.

FIG. 4 illustrates an embodiment of a migration process of FIG. 1.

FIG. 5 illustrates an embodiment of a centralized system for the system of FIG. 1.

FIG. 6 illustrates an embodiment of a logic flow for the system of FIG. 1.

FIG. 7 illustrates an embodiment of a computing architecture.

FIG. 8 illustrates an embodiment of a communications architecture.

### DETAILED DESCRIPTION

Various embodiments are directed to facilitating a migration process of source data from an enterprise system to an external system hosting services over a network. As described herein, these services include cloud-based services, such as a cloud storage service or a cloud computing service. The enterprise system may be concentrated in a centralized environment (i.e., on-premises facility) or a distributed environment (i.e., off-premises devices). When data items (i.e., files such as database records) are to be migrated, the embodiments described herein operate to convert the data items into a suitable migration dataset and then generate a script for storing the converted data items into a (cloud) storage location. The present disclosure describes these embodiments as being automatic and, in a single step, improving upon conventional techniques where the migration of any source data is spread out over several steps and one or more human operators. As described herein, the embodiments of the present disclosure herein refer to an improved migration process where (more or less) a single component (e.g., an executable pipeline) performs the above-mentioned source data conversion and script generation.

It is appreciated that the present disclosure describes embodiments that leverage configuration information to enable the improved migration process. In the various embodiments, carefully designed configuration information prepares a system to automatically migrate any source data to cloud storage. A portion of the configuration information includes various settings related to a cloud storage service. Having the various settings beforehand, the system of the present disclosure may automatically convert the data items into the migration dataset and generate a script for loading the converted data items of the migration dataset. The script may instruct the cloud storage service on storing the convert data items based upon a data model in operation at a storage location for the migration dataset.

To illustrate by way of example, when a file (e.g., a media file or a database record) or a set of files arrives at an on-premises facility for migration to the cloud storage service, the system described herein accesses the settings in the configuration information, converts the file or set of files into a migration dataset, and communicates a script to the cloud storage service. It is appreciated that in some embodiments, the script may be deployable from the cloud storage service, eliminating any requirement that the system generates and communicates the script. In other embodiments, the system invokes an executable pipeline that is pre-configured with modules corresponding to the settings, eliminating any requirement that the system access the settings.

It is further appreciated that prior to the present disclosure, the file or set of files would have had to be manually configured by personnel for that migration. Often, a team of professionals must define various settings for the migration process and then enter those settings each time a file is to be migrated. More importantly, the team operates in a step-by-step process such that some settings are entered consecutively.

With general reference to notations and nomenclature used herein, the detailed descriptions which follow may be presented in terms of program processes executed on a computer or network of computers. These process descriptions and representations are used by those skilled in the art to most effectively convey the substance of their work to others skilled in the art.

A process is here, and generally, conceived to be a self-consistent sequence of operations leading to the desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general-purpose digital computers or similar devices.

Various embodiments also relate to apparatus or systems for performing these operations. This apparatus may be specially constructed for the required purpose, or it may comprise a general-purpose computer as selectively activated or reconfigured by a computer program stored in the computer. The processes presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

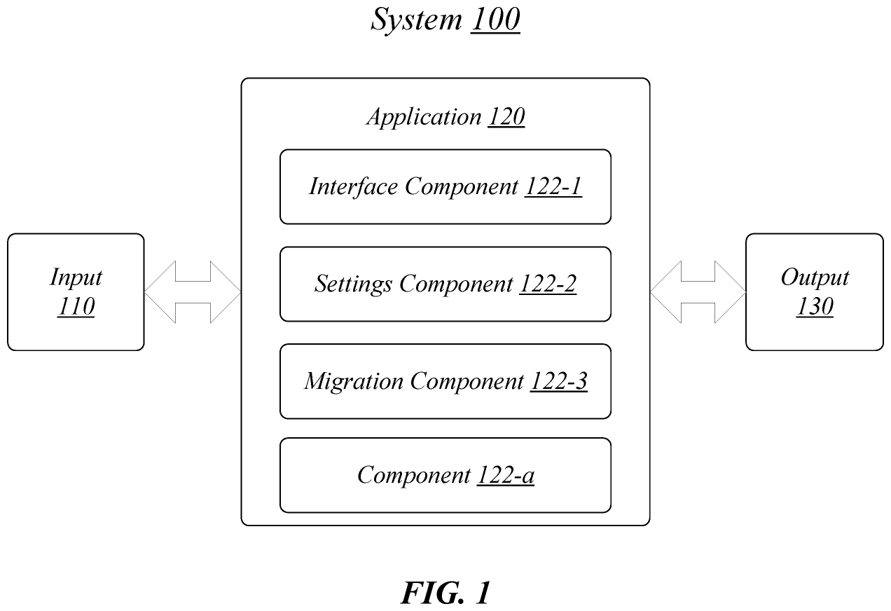

FIG. 1 illustrates a block diagram for a system 100. In one embodiment, the system 100 may comprise a computer-implemented system 100 having a software application 120 comprising one or more components 122-a. Although the system 100 shown in FIG. 1 has a limited number of elements in a certain topology; it may be appreciated that the system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-4, 122-5, 122-6, 122-7, and 122-8. The embodiments are not limited in this context.

The system 100 may comprise the application 120. As mentioned above, the system 100 includes the application 120 as a type of software application running on an electronic device, such as a desktop application running on an operating system of a computing device, a mobile application running on a mobile operating system of a mobile device, or a web application running on a browser component of either the mobile operating system or the desktop operating system. Those skilled in the art would understand how to design, build, and deploy the software application on any type of electronic device.

The application 120 may be generally arranged to process input 110, of which some input may be provided directly to an interface component 122-1 via an input device, and other input may be provided to the interface component 122-1 via a network. For example, a user may enter data via a keyboard device attached to a computing device running the application 120. The application 120 may be generally arranged to generate output 130 for the interface component 122-1 of which some output may be configured for display on a display device, and other output may be communicated across the network to other devices. As an example, the application 120 may generate data that can be processed/rendered by the interface component 122-1 into content for a Graphical User Interface (GUI).

The application 120 may be generally arranged to provide a practical improvement by way of a settings component 122-2 and a migration component 122-3. As described herein, the migration component 122-3 may represent a single component for executing a migration process automatically for a set of files to cloud storage. An example embodiment of the migration component 122-3 is an executable pipeline of modules that are executed (in an ordering) to complete the migration process such that the set of files is maintained by a cloud storage service. As described herein, the executable pipeline includes a set of modules that in general secure the set of files from misappropriation (e.g., via tokenization and/or encryption), ensure proper formatting and/or encoding, and provide a proper interface for loading the set of files into a storage location at the cloud storage service.

The application 120 may further comprise the settings component 122-2. The settings component 122-2 may be generally arranged to accept user input and generate configuration information (i.e., settings) for the above-mentioned migration process for source data to the storage location in the cloud storage. The present disclosure envisions the configuration information as encompassing any data related to facilitating the above-mentioned migration process; it is appreciated that the present disclosure does not foreclose on any particular area of the migration process to configure by way of such configuration information. The configuration information generally includes settings for modifying files in preparation for the migration process. Example settings include but are not limited to an encoding format, a file format, a tokenization parameter, an encryption scheme, and/or a compression scheme. Other example settings include a network address and other identification information for the cloud storage service maintaining the storage location for the modified files. As an alternative, the configuration information may identify a proxy computer for the cloud storage service. Other example settings may refer to control directives on scripting the migration process.

The migration component 122-3 may be generally arranged to process the configuration information mentioned above. In some embodiments, the migration component 122-3 is configured to use that information to convert the file data into a migration dataset suitable for the cloud storage service, generate a script to load the modified file data into the storage location, and communicate that script to the cloud storage service for execution. The script may be compatible with an electronic device running the application 120 and/or with a dedicated proxy computer residing between the electronic device and the cloud storage service.

In some embodiments, the settings component 122-2 may build the migration component 122-3 using the above-mentioned configuration information. In this manner, the settings component 122-2 combines a set of computing modules into the migration process where some modules perform tasks converting the file data/the modified file data, and some modules perform tasks generating/communicating a script to the cloud storage service. The set of computing modules can be invoked as a group or an executable pipeline when needed (i.e., dynamically). As such, the migration component 122-3 is ready for deployment when the files arrive for migration to the cloud storage service. A user may drag-and-drop a file to migrate into an icon corresponding to the migration process, and the user's device can execute the migration component to complete the migration process.

In some embodiments, the migration component 122-3 implements the migration process as a method having a step of accessing the configuration information associated with migrating source data to the cloud storage, the configuration information comprising settings directed towards storing the source data in the cloud storage. The migration component 122-3 performs a step of converting the file data into a migration dataset in accordance with the settings in the configuration information and applying a tokenization mechanism to a portion of the file data having target data, the portion being identified in the settings in the configuration information. In embodiments, the system may convert the file data in response to receiving the file data over the network. The tokenization mechanism is an example of the above-mentioned computing module and, when executed, replaces the target data with a token value (e.g., a Bank Account Value). The configuration information may include byte addresses (e.g., offsets) for the target data. A byte address may identify a data field or another content item having the target data. The configuration information may also include a file name, a file type, etc. associated with the target data to tokenize.

The migration component 122-3 performs a step of generating a script having operations for storing the migration dataset based upon the settings in the configuration information. As described herein, the migration component 122-3 may provide an interface through which the user may provide a script having instructions written in a scripting language (e.g., ANSIBLE® Playbooks™, Python™, Ruby™, Shell™ PowerShell™, and/or the like). The migration component 122-3 may communicate the script in a control directive to a server managing the cloud storage service. The server, which invokes an associated cloud computing service to execute the script, may be associated with a network address provided in the settings of the configuration information. In some alternative embodiments, the cloud computing service may execute the tokenization mechanism. In other alternative embodiments, the migration component 122-3 may provide an interface that processes code in a non-scripting language that operates similarly as the script. The cloud computing service is configured to store the migration dataset in the storage location in accordance with the settings in the configuration information.

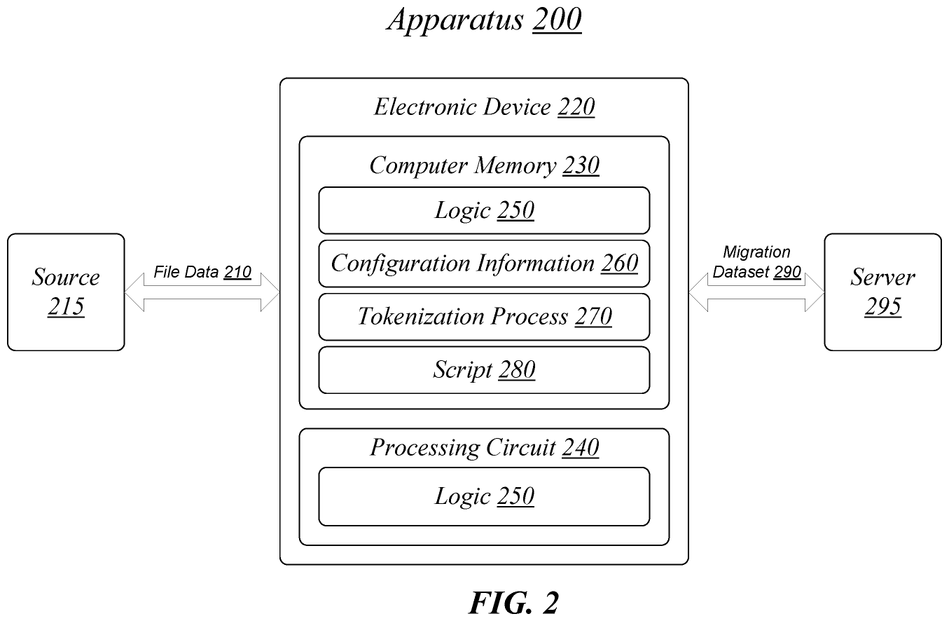

FIG. 2 illustrates an embodiment of an apparatus 200 for the system 100. As shown in FIG. 2, file data 210 originating from a source 215 is processed by an electronic device 220 having computer memory 230 and a processing circuit 240. It is appreciated that the file data 210 includes files of various file formats and/or encoding formats. The computer memory 230 stores logic 250 that, when executed in the processing circuit 240, provides services related to migrating that file data 210 to cloud storage. Some files are database records for addition to a database system being stored in cloud storage.

Execution of the logic 250, when stored in the computer memory 230, is operative to cause the processing circuit 240 to access configuration information 260 associated with migrating any source data to the cloud storage. The configuration information 260 includes settings directed towards migrating and storing the file data 210 to a storage location in the cloud storage. Some settings include an encoding format, a file format, etc. for individual files in the file data 210. Furthermore, the configuration information 260 includes at least an address (e.g., a network address, such as a uniform resource locator (URL)) directing the logic 250 to the storage location or at least a device managing the storage location. The configuration information 260 further includes data and control inputs for securing the file data 210 during the migration process. For example, the configuration information 260 may specify which tokenization process 270 to use and identify which portion(s) of the file data 210 is to be tokenized. With respect to the tokenization process 270, the present disclosure is referring to any process that replaces data with a unique identifier known as a token (e.g., a Bank Account Number (BAN)). The configuration information 260 may also specify which encryption scheme to use in encrypting the file data 210. It is appreciated that the present disclosure does not limit the configuration information 260 to any particular combination of settings and, therefore, covers any settings corresponding to the migration process to the cloud storage. As described herein, some of these settings are used as inputs for variables in a script 280 for storing secured file data 210 in the storage location in the cloud storage.

The logic 250 is configured to cause the processing circuit 240 to convert the file data 210 into a migration dataset 290 in accordance with the settings in the configuration information 260. The logic 250 is configured to use the settings to modify portions of the file data 210 to ensure that the script 280 successfully loads the modified file data 210 into the cloud storage. The storage location, in some instances, may require the proper encoding format and/or file format. In addition to identifying a proper encoding format, the configuration information 260 may also include a proper file format for converting the file data 210 into the migration dataset 290.

The configuration information 260 includes additional information to ensure a successful migration. As an example, the configuration information 260 includes a network address for the storage location into which the file data 210 is to be migrated over a network. As another example, the configuration information 260 may describe a data model identifying a structure of the file data 210, including whether the file data 210 includes database records or other datasets. In some embodiments, the structure of the file data 210 may refer to an arrangement of attributes in a database record. By way of the data model, the configuration information 260 may delineate byte addresses where target data is stored in the migration dataset 290. The script may be generated to include instructions where whole database records or individual data attributes are loaded into corresponding byte addresses in the storage location. It is appreciated that the corresponding byte addresses are logical addresses that are translated by the cloud storage service into physical addresses on a physical storage device.

The logic 250 is configured to cause the processing circuit 240 to apply the tokenization process 270 to a portion or portions of the migration dataset 290 having the target data. The logic 250 instructs the tokenization process 270 to replace the target data at the byte address with a token value, such as a Bank Account Number (BAN). In some embodiments, the target data may include one or more data fields in a set of database records.

The logic 250 is configured to cause the processing circuit 240 to generate the script 280 to include operations for storing the migration dataset 290 in accordance with the settings of the configuration information 260. In some embodiments, the logic 250 may insert into the script 280 the network address of the storage location such that the script 280 communicates the migration dataset 290 to an appropriate external system running cloud storage supporting services.

The logic 250 is configured to cause the processing circuit 240 to communicate the script 280 and the migration dataset 290 to a server 295. In some embodiments, the server 295 is an external computer system running cloud storage supporting services and corresponding to the network address of the storage location. Communications directed toward that network address are routed over the network to the server. The server 295 may be configured to execute the script 280 and store the migration dataset 290 in the storage location in accordance with the settings in the configuration information 260. Operations defined within the script 280 may direct the server 295 to load individual files or records into a file system or a database system, respectively. As an alternative, a dedicated proxy computer may reside between the device 220 and the server 295, and that dedicated proxy computer is configured to receive and execute the script 280 and then store the migration dataset 290 at byte addresses in the cloud storage.

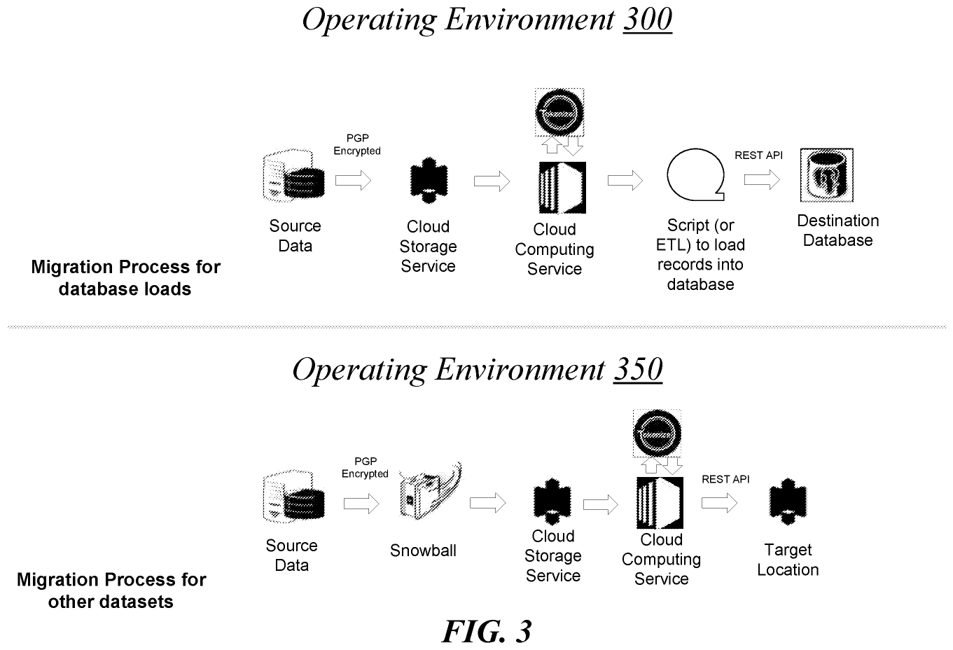

FIG. 3 illustrates embodiments of an example operating environments for the system 100. As shown in FIG. 3, an operating environment 300 illustrates a migration process for database loads, and an operating environment 350 illustrates a migration process for other datasets.

In the operating environment 300, source data (e.g., off-premises data or on-premises data) is initially encrypted via PGP technology and then communicated to a server running a cloud storage service (e.g., AMAZON® S3™). It is appreciated that such a cloud storage service may be referred to as a web service due, in part, to the service's implementation of various Internet and web technologies. To illustrate by way of an example, the server running the cloud storage service and a device requesting and configuring the cloud storage service may exchange data via a web interface, which may be a web browser application or any application capable of an Internet connection with the server. It is appreciated that the above-mentioned device may be different from devices providing the source data (i.e., off-premises data). The server running the cloud storage service may utilize a cloud computing service (e.g., AMAZON® EC2™) for various tasks, such as tokenization. In some embodiments, a server running the cloud computing service may distribute the execution of the various tasks across a plurality of computing nodes (e.g., virtual machines). After completing the tokenization of the source data, the server running the cloud computing service may execute a script to load records into a destination database. The operating environment 300 implements the destination database as a MICROSOFT® AZURE® PostGRESQL™ database.

In the operating environment 350, the system 100 encrypts source data (e.g., on-premises data) using an encryption scheme. The operating environment 350 implements an accelerator device, known as a Snowball, to accelerate data transfer of the source data to a storage location in the cloud storage service. The Snowball, in general now, provides a service that accelerates transferring large amounts of the source data into and out of the cloud storage service using physical storage devices. This may be done by shipping the source data in the physical storage devices through a regional carrier, bypassing the Internet. Each Snowball device may transport data at faster-than internet speeds.

The server running the cloud storage service utilizes the cloud computing service to tokenize portions of the source data. These portions include some type of target data for the system 100. The target data may include sensitive or private information such as a social security number or an identifying photo. The cloud computing service, as instructed by the cloud storage service, replaces the target data with a token value, such as a Bank Account Number. After completing the tokenization process, the cloud storage service via the REST™ API into a target location in the cloud storage's infrastructure.

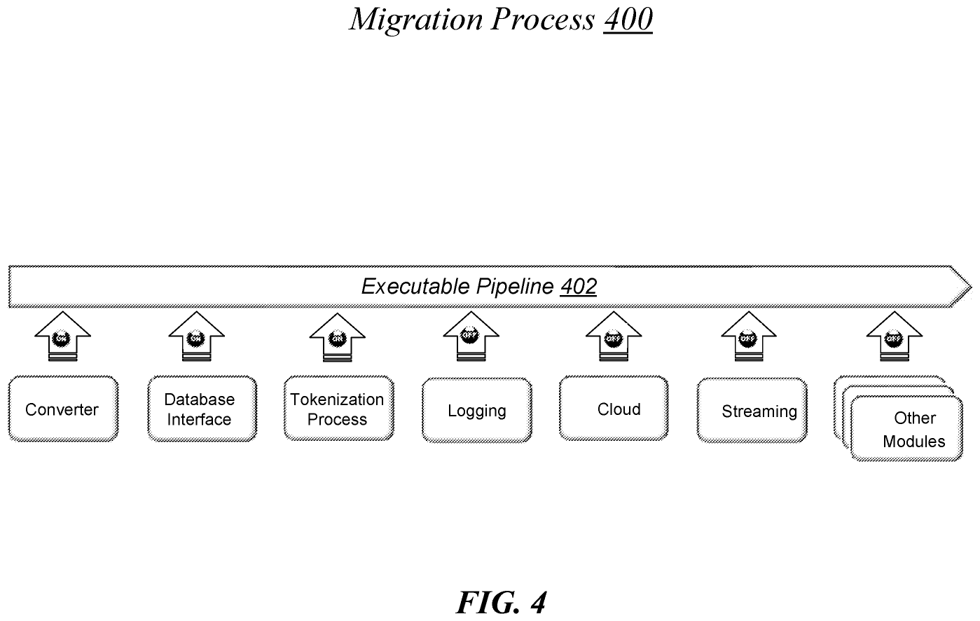

FIG. 4 illustrates an embodiment of a migration process 400 for the system 100. As shown in FIG. 4, an executable pipeline 402 of modules may implement the migration process 400 for a particular operating environment. FIG. 4 further illustrates a modular aspect of the migration process 402 in that the executable pipeline 402 can be adapted in accordance with settings defined by one or more users. These settings can be consolidated into configuration information (e.g., the configuration information 260 of FIG. 2).

There are a considerable number of combinations of modules for coupling with the executable pipeline 402; as an example, FIG. 4 illustrates the executable pipeline 402 as invoking a converter, a database interface, and a tokenization process. The converter is a component capable of modifying an encoding format and/or a file format for any source data. The converter provides an API through which the executable pipeline 402 can provide source data to modify into converted source data. The database interface provides functionality for executing software code operative to load the converted source data into a database system and/or access any data in that database system. Java Database Connectivity (JDBC), an example database interface, is an application programming interface (API) for the programming language Java. The tokenization process (e.g., Turing 3.0) replaces target data (e.g., sensitive information) in the converted source data with token data. With addresses for data fields having the target data, one example embodiment of the tokenization process replaces data stored in those data fields with a token value.

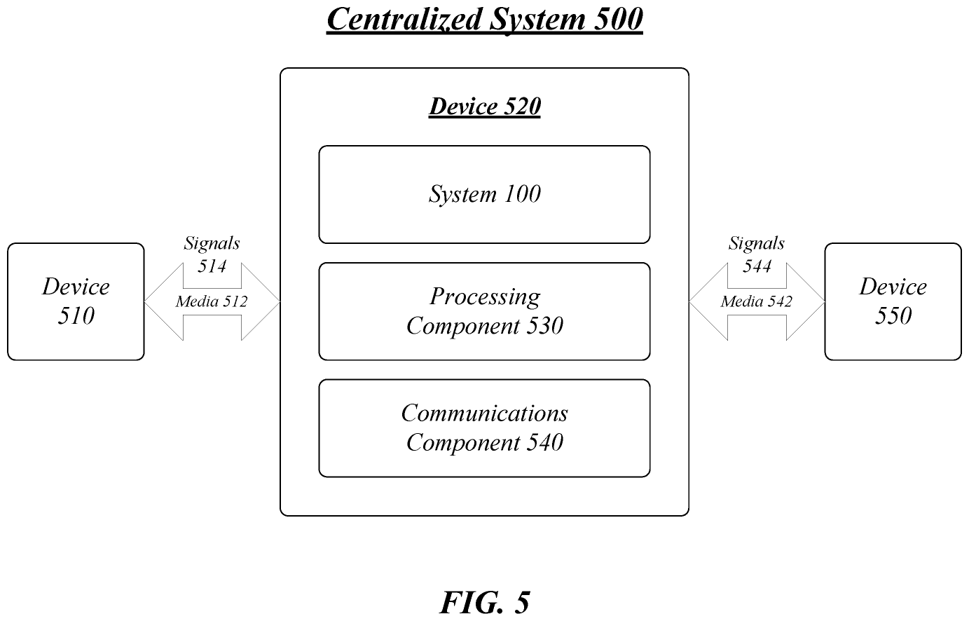

FIG. 5 illustrates a block diagram of a centralized environment 500. The centralized environment 500 may implement some or all of the structure and/or operations for the system 100 in a single computing entity, such as entirely within a single device 520.

The device 520 may comprise any electronic device capable of receiving, processing, and sending information for the system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 520 may execute processing operations or logic for the system 100 using a processing component 530. The processing component 530 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application-specific integrated circuits (ASIC), programmable logic devices (PLD), digital signal processors (DSP), field-programmable gate array (FPGA), Application-specific Standard Products (ASSPs), System-on-a-chip systems (SOCs), Complex Programmable Logic Devices (CPLDs), memory units, logic gates, registers, semiconductor device, chips, microchips, chipsets, and so forth. Examples of software elements may include software components, programs, applications, computer programs, application programs, system programs, software development programs, machine programs, operating system software, middleware, firmware, software modules, routines, subroutines, functions, methods, procedures, processes, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 520 may execute communications operations or logic for the system 100 using communications component 540. The communications component 540 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 540 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 512, 542 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 520 may communicate with other devices 510, 550 over a communications media 512, 542, respectively, using communications signals 514, 544, respectively, via the communications component 540. The devices 510, 550 may be internal or external to the device 520 as desired for a given implementation.

As an alternative, a distributed environment distributes portions of the structure and/or operations for the system 100 across multiple computing entities. Examples of a distributed environment may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

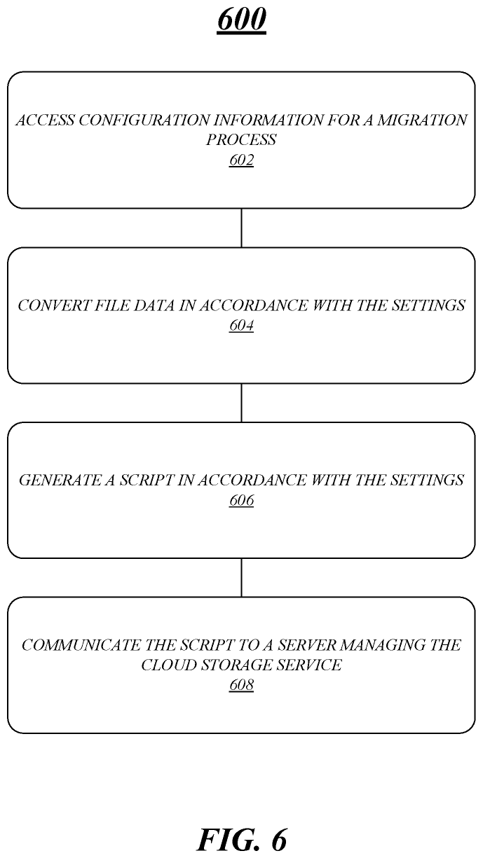

FIG. 6 illustrates one embodiment of a logic flow 600. The logic flow 600 may be representative of some or all of the operations executed by one or more embodiments described herein.

In the illustrated embodiment shown in FIG. 6, the logic flow 600 to access configuration information for a migration process at block 602. In general, the configuration information includes settings on preparing source data for the migration process. In some embodiments, one or more example settings identify which modules to use in building or generating an executable pipeline for this migration process and future migration processes. As described herein, the executable pipeline refers to a dynamic set of modules representing distinct sub-processes that when executed in some order, form the migration process. The system may add computing modules to the executable pipeline or remove computing modules to the executable pipeline to perform the migration process. Some of these sub-processes secure the source data from misappropriation, such as a tokenization mechanism, an encryption scheme, and/or the like. Other modules provide APIs to prepare (e.g., convert) the source data into a migration dataset suitable for the migration process. One example module provides an interface that is operative to transform user-submitted JAVA code into a script for loading the migration dataset and completing the migration process.

In some embodiments, some example settings of the configuration information describe instructions on modifying source data, enabling the migration process of that source data to cloud storage. As described herein, the logic flow 600 may access settings indicating a network address (e.g., an IP address) of a cloud storage service that is configured for administrating the actual storage of the source data. The settings may also include a data model describing how to arrange data items in the source data such that an individual data item can be identified. The data model, in general, describes the source data's structure in terms of composite data items and their data types. If the data model describes a database, the data model identifies rows/columns in a database table as well as any indices. Each row may refer to a database record comprising a set of data items of which each data item is addressable as a byte offset from a beginning of the database record. If the data model describes a file system, the data model identifies each folder and any data files within each folder.

The logic flow 600 may convert file data in accordance with the settings at block 604. It is appreciated that the logic flow 600 may perform the conversion in a distributed environment or a centralized environment. To illustrate by way of examples, the file data may be a set of files that are generated by a plurality of users and transmitted to a central, on-premises facility and scheduled for migration some time after reception. In another example, the file data may be a set of files that are maintained by a plurality of users at their devices and then, scheduled for migration (from the users' devices) at a fixed time and date.

In some embodiments, the logic flow 600 may convert the file data into an appropriate encoding format and/or file format for the cloud storage. Data items in the file data may be structured in accordance with a data model (e.g., a relational database model). The settings may identify byte addresses where target data for tokenization is stored. As described herein, the target data may include sensitive or private information. These byte addresses may refer to data fields (in database records) or data items (in other datasets) having the sensitive or private information. In some embodiments, the logic flow 600 may execute the tokenization process at an on-premises facility while, in other embodiments, the logic flow 600 may instruct a server hosting a cloud computing service to replace a portion of the file data with a token value.

The logic flow 600 may generate a script in accordance with the settings at block 606. For example, the logic flow 600 may run the script from the server hosting the cloud computing service to load the migration dataset into the storage location. The script may be configured in a variety of scripting languages (e.g., PowerShell). The settings in the configuration information describe the storage location at least in terms of physical and logical addresses. The settings may include a network address for the cloud computing service and/or a physical storage device corresponding to the storage location. The settings may also describe a data model in operation at the storage location; the data model introduces a logical addressing scheme for identifying stored data within the physical storage device.

If the migration dataset includes database records, the logic flow 600 inserts into the script database commands (e.g., SQL commands) that are configured to load these database records into a destination database. These database commands comply with a data model in operation at the destination database. If the migration dataset includes data items other than a type of database record, the logic flow 600 inserts into the script instructions that are configured to store these data items into a (destination) volume. Similar to approach used for the database records, the logic flow 600 generates the above-mentioned instructions to comply with a data model (e.g., a file system) in operation at the volume.

The logic flow 600 may communicate the script to a server or a dedicated proxy computer at block 608. The server described herein refers to a computer hosting the cloud computing service. For example, the logic flow 600 may invoke functionality through an interface to the cloud computing service where the invocation of such functionality instructs the server to run the script. The embodiments are not limited to this example.

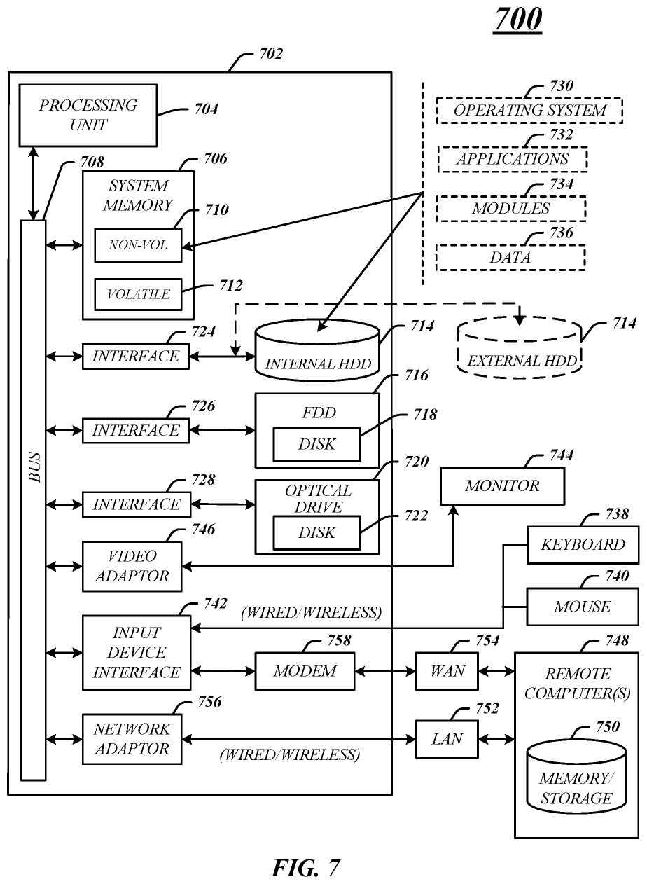

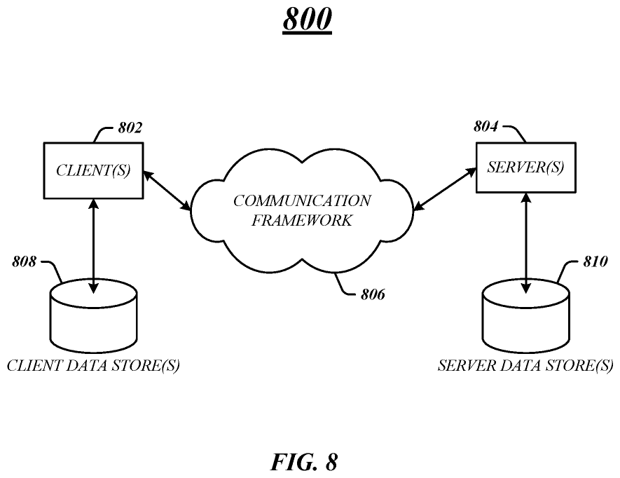

FIG. 7 illustrates an embodiment of an exemplary computing architecture 700 suitable for implementing various embodiments as previously described. In one embodiment, the computing architecture 700 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 704.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and Institute of Electrical and Electronics Engineers (IEEE) 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 comprises includes one or more clients 802 and servers 804. The clients 802 may implement the client device 910. The servers 804 may implement the server device 950. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques and protocols. The communications framework 806 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 806 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processing circuit; and
logic stored in computer memory and executed on the processing circuit, the logic operative to cause the processing circuit to:
access configuration information associated with migrating source data to a cloud storage service, the configuration information comprising settings directed towards storing the source data in the cloud storage service;
convert file data to be migrated to a storage location over a network into a migration dataset in accordance with the settings in the configuration information, the storage location corresponding to the cloud storage service;
generate a script for storing the migration dataset in the migration dataset, the script being generated based upon the settings in the configuration information; and
communicate the script and the migration dataset to a server associated with the cloud storage service, the server configured to execute the script and store the migration dataset in the storage location in accordance with the settings in the configuration information.

2. The apparatus of claim 1, comprising logic operative to cause the processing circuit to generate an executable pipeline based upon the settings in the configuration information and apply the executable pipeline to convert the file data in response to receiving the file data over the network.

3. The apparatus of claim 1, comprising logic operative to cause the processing circuit to communicate the migration dataset to a proxy server and instruct the proxy server to execute the script and communicate the migration dataset to the storage location.

4. The apparatus of claim 1, comprising logic operative to cause the processing circuit to apply a tokenization mechanism to a portion of the migration dataset having sensitive information, the portion being identified in the settings in the configuration information.

5. The apparatus of claim 1, comprising logic operative to cause the processing circuit to generate the script using a network address and a data model corresponding to the storage location, the network address and the data model being based upon the settings in the configuration information.

6. The apparatus of claim 1, comprising logic operative to cause the processing circuit to convert the file data according to an encoding format, the encoding format being based upon the settings in the configuration information.

7. The apparatus of claim 1 comprising logic operative to cause the processing circuit to access the settings comprising information to identify sensitive information within a file.

8. A computer-implemented method executed on a processing circuit, the method comprising:
accessing configuration information associated with migrating source data to a cloud storage service, the configuration information comprising settings directed towards storing the source data in a storage location of the cloud storage service;
converting file data into a migration dataset in accordance with the settings in the configuration information, including applying a tokenization mechanism to a portion of the file data having target data, the portion being identified in the settings in the configuration information;
generating a script for storing the migration dataset in the storage location, the script being generated based upon the settings in the configuration information; and
communicating the script and the migration dataset to a server managing the cloud storage, the server configured to execute the script and store the migration dataset in the storage location in accordance with the settings in the configuration information.

9. The computer-implemented method of claim 8, wherein the settings specify an encryption scheme for encrypting the file data for the migration dataset.

10. The computer-implemented method of claim 8, comprising generating an executable pipeline based upon the settings in the configuration information, the executable pipeline being operative to convert the file data.

11. The computer-implemented method of claim 10, comprising adding or removing computing modules to the executable pipeline.

12. The computer-implemented method of claim 8, wherein a token value to replace the portion having the target data comprises a bank account number.

13. The computer-implemented method of claim 8, comprising generating the script using a network address and a data model corresponding to the storage location, the settings in the configuration information comprising the network address and the data model.

14. The computer-implemented method of claim 8, comprising identifying sensitive information to tokenize within a database record.

15. At least one computer-readable storage medium comprising processor-executable instructions that, when executed, cause a system to:
accessing configuration information associated with migrating source data to cloud storage, the configuration information comprising settings identifying a storage location and a data model for storing the source data in the cloud storage;
in response to file data being migrated to the storage location over a network, converting the file data into a migration dataset in accordance with the settings in the configuration information;
apply a tokenization mechanism to a portion of the migration dataset having sensitive information, the portion being identified in the settings in the configuration information;
generate a script for storing the migration dataset into the storage location, the script being generated based upon the settings in the configuration information; and
communicate the script and the migration dataset to a server managing the cloud storage, the server configured to execute the script and store the migration dataset in the storage location in accordance with the settings in the configuration information.

16. The computer-readable storage medium of claim 15, comprising processor-executable instructions that when executed, cause the system to: generate the script in accordance with a data model specified in the settings in the configuration information.

17. The computer-readable storage medium of claim 15, comprising processor-executable instructions that when executed, cause the system to: instruct a dedicated proxy computer to communicate the source data from the storage location.

18. The computer-readable storage medium of claim 15, comprising processor-executable instructions that when executed, cause the system to: generate the script to load database records into a destination database.

19. The computer-readable storage medium of claim 15, comprising processor-executable instructions that when executed, cause the system to: generate an executable pipeline based upon the settings in the configuration information, the executable pipeline being operative to convert the file data.

20. The computer-readable storage medium of claim 19, comprising processor-executable instructions that when executed, cause the system to: add computing modules to the executable pipeline or remove computing modules to the executable pipeline.
